(19) United States
(12) Patent Application Publication
(10) Pub. No.: US 2014/0265301 A1
(43) Pub. Date: Sep. 18, 2014

(54) SECURITY FEATURE UTLIZING HINGE MATERIAL AND BIODATA PAGE

(71) Applicant: 3M INNOVATIVE PROPERTIES COMPANY, St. Paul, MN (US)

(72) Inventors: Christopher K. Haas, St. Paul, MN (US); Todd D. Jones, St. Paul, MN (US); Kui Chen-Ho, Woodbury, MN (US)

(73) Assignee: 3M INNOVATIVE PROPERTIES COMPANY, St. Paul, MN (US)

(21) Appl. No.: 13/844,629

(22) Filed: Mar. 15, 2013

(51) Int. Cl. B42D 15/00; B42B 5/00

(52) U.S. Cl. CPC B42D 15/00; B42B 5/00
USPC 283/85; 29/428; 412/6

(57) ABSTRACT

An article may include a flexible hinge comprising a first optical feature. The article also may include a biodata page comprising a second optical feature. The flexible hinge may be attached to a surface of the biodata page, and the second optical feature is substantially aligned with the first optical feature. The combination of the first optical feature and the second optical feature provides an optical effect, which may be destroyed or damaged if the flexible hinge is moved relative to the biodata page, e.g., if the flexible hinge is separated from the biodata page.

### TECHNICAL FIELD

The disclosure relates to security documents, such as biodata pages for passports.

### BACKGROUND

Security articles, such as security documents and identification documents, are becoming increasingly important. Examples of identification documents include, but are not limited to, passports, driver's licenses, national ID cards, border crossing cards, security clearance badges, security cards, visas, immigration documentation and cards, gun permits, membership cards, phone cards, stored value cards, employee badges, debit cards, credit cards, and gift certificates and cards. Security articles may include personal identification information, which must be kept secure from tampering to ensure that counterfeiters or tamperers cannot produce counterfeit security articles or tamper with genuine security articles.

For example, passports include a biodata page that includes relevant personal information for the passport holder, including, for example, the passport holder's name, date of birth, photograph, citizenship, etc. Increasingly, the biodata page is formed of polymer materials, such as polycarbonate. The biodata page may be printed or engraved with the passport holder's personal information and other relevant information. Additionally, the biodata page may include security features, such as radio frequency identification (RFID) chips, fluorescent dyes, surface structures (including graphics, text, diffractive elements, refractive elements, or the like), polarizing components, holograms, security printing such as rainbow guilloche or color-shifting inks, and the like, which increase the difficulty of modifying or replacing information carried by the biodata page by an unauthorized person without detection.

In some examples, the biodata page may be attached to a flexible material that forms a hinge for attaching the biodata page to the remainder of the passport. The connection between the biodata page and the hinge may be a target for tamperers or counterfeiters, who may attempt to separate the hinge from the biodata page to, for example, replace the biodata page with a counterfeit biodata page.

### SUMMARY

The disclosure describes a composite security feature for an article including a biodata page and a flexible hinge and methods for forming the composite security feature. The composite security feature may include a first optical feature formed in the flexible hinge and a second optical feature formed in the biodata page. The first optical feature and second optical feature may produce an optical effect when substantially in registration (e.g., in registration or nearly in registration) with each other, such as when the mechanical connection between the flexible hinge and biodata page (as originally manufactured) is intact. However, the optical effect may be modified, distorted, damaged, or destroyed when the first optical feature and second optical feature are not substantially in registration with each other, such as when the flexible hinge and biodata page have been separated and reattached or when a different hinge has been attached to the biodata page or a different biodata page has been attached to the hinge. In this way, the composite security feature may indicate tampering with the article and may make successful (e.g., undetected) tampering or counterfeiting more difficult.

In some examples, the composite security feature may be personalized, e.g., may include personal information. For example, when the biodata page is part of a passport booklet, the personal information may include information identifying or unique to the holder of the passport, such as a picture, name, signature, biographical data, or the like. In some examples, the article may be initially formed including the first optical feature and may be sold to a customer, such as an issuer of the passport booklet. As part of issuing the passport booklet to the passport holder, the second optical feature may be formed in the biodata page, e.g., by engraving a laser-sensitive material in the biodata page with the personal information, such that the first optical feature and the second optical feature are substantially aligned with each other and produce the optical effect. If a tamperer then tampers with the article including the flexible hinge and biodata page by moving the flexible hinge relative to the biodata page, the alignment between the first and second optical features may be lost, which may modify, distort, damage, or destroy the optical effect and indicate the tampering.

In one example, the disclosure describes an article that includes a flexible hinge comprising a first optical feature. The article may also include a biodata page comprising a second optical feature. The flexible hinge may be attached to a biodata page surface, and the second optical feature is substantially aligned with the first optical feature.

In another example, the disclosure describes a method of forming an article comprising a biodata page, the method comprising forming a flexible hinge comprising a first optical feature. In accordance with this example, the method also may include attaching the flexible hinge to the biodata page. The biodata page may include a second optical feature substantially aligned with the first optical feature when the flexible hinge is attached to the biodata page.

In a further example, the disclosure describes an article including a flexible hinge comprising a plurality of lenses, each of the lenses defining a focal point. The article may also include a layer comprising a radiation sensitive material. The layer may be attached to the flexible hinge, and focal points of a set of lenses of the plurality of lenses may lie within the radiation sensitive material.

In an additional example, the disclosure describes a method comprising forming a flexible hinge comprising a plurality of lenses, each of the lenses defining a focal point. The method also may include attaching the flexible hinge to a layer comprising a radiation sensitive material. The focal points of a set of lenses of the plurality of lenses may lie within the radiation sensitive material.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual diagram illustrating an example of a passport document including a biodata page in accordance with one or more examples of the disclosure.

FIGS. 2 and 3 are conceptual and schematic diagrams illustrating examples of assemblies including a flexible hinge, a biodata page, and a composite security feature formed by a first optical feature formed on a surface of the flexible hinge and a second optical feature formed on or in the biodata page.

FIGS. 4-6 are conceptual and schematic diagrams illustrating examples of a flexible hinge including a plurality of microlenses.

FIGS. 7-10 are conceptual and schematic diagrams illustrating examples of assemblies including a flexible hinge, a biodata page, and a composite security feature formed by a first optical feature formed on a surface of the flexible hinge and a second optical feature formed on or in the biodata page.

FIGS. 11 and 12 are flow diagrams illustrating example methods for forming assemblies including a composite security feature formed by a first optical feature on a flexible hinge and a second optical feature on or in a biodata page attached to the flexible hinge.

### DETAILED DESCRIPTION

The disclosure describes a composite security feature for an article including a biodata page and a flexible hinge. The disclosure also describes methods for forming the article including the composite security feature. The composite security feature may include a first optical feature formed in the flexible hinge and a second optical feature formed in the biodata page. The first optical feature and second optical feature may produce an optical effect when substantially in registration (e.g., in registration or nearly in registration) with each other, such as when the mechanical connection between the flexible hinge and biodata page (as originally manufactured) is intact. However, the optical effect may be modified, distorted, damaged, or destroyed when the first optical feature and second optical feature are not substantially in registration with each other, such as when the flexible hinge and biodata page have been separated and reattached or when a different hinge has been attached to the biodata page or a different biodata page has been attached to the hinge. In this way, the composite security feature may indicate tampering with the article and may make successful (e.g., undetected) tampering or counterfeiting more difficult.

The composite security features may include, for laser-engraved floating images, color floating images, Moire magnification, aligned partial images that together form a complete image, or the like. Substantial registration or substantial alignment that produces the desired optical effect may depend on the particular composite security feature, and may be as little as 40 micrometers in some instances, i.e., if the first and second optical features are out of registration by more than 40 micrometers, the optical effect may be distorted or destroyed. In other examples, the optical effect may be produced when the first and second optical features are aligned within about 20 micrometers, or within about 10 micrometers, or within about 4 micrometers (i.e., a lack of alignment of greater than about 20 micrometers, or greater than about 10 micrometers, or greater than about 4 micrometers may cause the optical effect to be distorted or destroyed).

In some examples, the composite security feature may be able to be personalized. The term “personalized” as used herein, including the claims, means that a composite security feature includes information that is personal, that is, pertaining to, or coming as from a particular person or individual. For example, there are at least two different broad categories of personal information. One category is often referred to as “biographical information.” Biographical information may include, for example, a person's name, address, social security number, date of birth, or ID number. Another category is often referred to as “biometric information.” Biometric information includes any physiological or behavioral trait that is universal, distinctive, permanent, and collectible. Physiological biometric traits are typically related to a body trait, and include but are not limited to: fingerprint, face, DNA, palm print, hand geometry, iris recognition. For example, biometric information may include color of eyes, weight, hair color, or other data attributed to a physiological biometric trait.

In some examples, the article may be initially formed including the first optical feature and may be sold to a customer, such as an issuer of the passport booklet. As part of issuing the passport booklet to the passport holder, the second optical feature may be formed in the biodata page, e.g., by engraving a laser-sensitive material in the biodata page with the personal information, such that the first optical feature and the second optical feature are substantially aligned with each other and produce the optical effect.

If an article including a flexible hinge and a biodata page includes a personalized composite security device, it makes it more difficult to copy or alter the article without detection. Security articles are becoming increasingly important. Examples of security articles that may incorporate the article described herein include identification documents and value documents. The term identification documents is broadly defined and is intended to include, but not be limited to, for example, passports, driver's licenses, national ID cards, social security cards, voter registration and/or identification cards, birth certificates, police ID cards, border crossing cards, security clearance badges, security cards, visas, immigration documentation and cards, gun permits, membership cards, and employee badges. Value documents include items of value, such as, for example, currency, bank notes, checks, phone cards, stored value cards, debit cards, credit cards, gift certificates and cards, and stock certificates, where authenticity of the item is important to protect against counterfeiting or fraud. The article of this disclosure may be the security article or may be part of the security article.

FIG. 1 is a conceptual diagram illustrating an example passport booklet that includes an article including a biodata page and flexible hinge in accordance with some examples of the disclosure. Passport booklet 10 is typically a booklet filled with several bound pages 12a-12f and 14. One of the bound pages is a biodata page 14, and includes personalized data, often presented as printed or engraved indicia or images. The personalized data contained by biodata page 14 can include one or more photographs 16, signatures, personal alphanumeric information 18, and barcodes, and allows human or electronic verification that the person presenting passport booklet 10 for inspection is the person to whom the passport booklet 10 is assigned. Biodata page 14 also may include a variety of covert and overt security features, such as those security features described in U.S. Pat. No. 7,648,744, entitled, “Tamper-Indicating Printable Sheet for Securing Documents of Value and Methods of Making the Same,” the entire content of which is incorporated herein by reference.

In addition, biodata page 14 is attached to a flexible hinge 20. Flexible hinge 20 facilitates connection of biodata page 14 to the remaining pages 12a-12f of passport booklet 10. For example, flexible hinge 20 may be sewn, stitched, or otherwise bound to the remaining pages to integrate biodata page 14 into passport booklet 10. In some examples, flexible hinge 20 may be sewn to pages 12a-12f of passport booklet 10 using a security thread to increase the difficulty of forcibly removing biodata page 14 (and flexible hinge 20) from the passport booklet 10. Flexible hinge 20 may be flexible at room temperature, having a modulus of between about 0.1 megaPascals (MPa) and about 200 MPa, such as between about 0.1 MPa and about 100 MPa. Such a modulus allows flexible hinge 20 to bend when passport booklet 10 is closed.

Biodata page 14 and flexible hinge 20 together form an article that includes a composite security feature. The composite security feature includes a first optical feature formed on a surface of flexible hinge 20 and a second optical feature formed on a surface of or within biodata page 14. FIGS. 2, 3, and 6-9 are conceptual and schematic diagrams illustrating examples of composite security features that can be used with the article formed by biodata page 14 and flexible hinge 20.

As shown in FIG. 2, article 30 includes a flexible hinge 32 and a biodata page 34. Formed in a first hinge surface 36 of flexible hinge 32 is a first optical feature 44. Second hinge surface 38 is substantially opposite of first hinge surface 36. In the example shown in FIG. 2, second hinge surface 38 is attached to a first biodata page surface 40. Second hinge surface 38 may be attached to first biodata page surface 40 using, for example, lamination, an adhesive, ultrasonic welding, solvent welding, thermal welding, hot gas welding, contact welding, friction welding, or the like.

In the example of FIG. 2, first biodata page surface 40 is stepped down from second biodata page surface 42, which is substantially parallel to first biodata page surface 40. In some examples, the distance D between first biodata page surface 40 and second biodata page surface 42, as measured in the z-axis direction of FIG. 2 (where orthogonal x-y-z axes are shown for ease of description only), may be substantially equal to a thickness of flexible hinge 32 (as measured in the z-axis direction of FIG. 2). This may allow first hinge surface 36 to be substantially co-planar with second biodata page surface 42. In other examples (e.g., as shown in FIG. 9A), biodata page 34 may not include first biodata page surface 40 and second biodata page surface 42, and may instead include a single, substantially planar surface to which second hinge surface 38 is attached. In such examples, first hinge surface 36 may not be substantially co-planar with the surface of biodata page 34.

In some examples, the step between first biodata page surface 40 and second biodata page surface 42 may be formed during the initial manufacturing of biodata page 34. For example, biodata page 34 may be formed using a molding process, and the mold may define the step between first biodata page surface 40 and second biodata page surface 42. In other examples, biodata page 34 may first be formed as a planar surface corresponding to second biodata page surface 42, and material may be removed from biodata page 34 to define first biodata page surface 40. In some implementations, milling may be used to remove the material from biodata page 34 and define first biodata page surface 40.

Biodata page 34 may include a material into which or onto which personal data may printed or engraved. In some examples, biodata page 34 may include at least one polymer. The polymer may include, for example, polycarbonate (PC), high density polyethylene (HDPE), polyethylene terephthalate (PET), or the like.

In some examples, biodata page 34 may include one or more security features embedded within or formed on a surface of biodata page 34. The security features may include any security features known to those of skill in the art, such as holograms; color images within the biodata page 34 (e.g., on a surface of a sublayer of biodata page 34 prior to attaching the sublayers to form biodata page 34); a radio frequency identification (RFID) chip; one or more fluorescent dyes; one or more taggants; one or more surface structures, which may form graphics, text, diffractive elements, and/or refractive elements; one or more embedded structures; one or more polarizing components; a color-shifting film; a security thread; guilloche printing; color-shifting ink printing; or the like.

Flexible hinge 32 may include a flexible material that includes sufficient tear resistance and flexibility to withstand repeated bending during use of the passport booklet, e.g., over a time period of up to 10 years or more. In some examples, flexible hinge 32 may include at least one polymer, such as an elastomer. Example elastomers that may be used for flexible hinge 32 include thermoplastics, such as polyurethane. In some instances, instead of a thermoplastic material, a thermoset material may be used for flexible hinge 32. For example, flexible hinge 32 may include a thermoset elastomeric polyurethane.

As used herein, a thermoset cross-linked polyurethane is defined as a polyurethane that has been irreversibly cross-linked, i.e. through covalent bonding, in such a way as to provide a polyurethane which is resistant to flow, even under elevated temperatures. The extent of cross-linking in a thermoset polymer can be determined through measurement of the gel content, or fraction of insoluble material when a sample of the polyurethane is immersed in a known good solvent. Thermoset cross-linked polyurethanes useful in this invention contain at least 40% gel content. In some examples, the thermoset cross-linked polyurethanes may include at least 48% gel content, or at least 55% gel content. Without wishing to be bound by theory, thermoset polymers cannot be reprocessed by simple heating, i.e., extrusion; after cross-linking, the materials form an irreversible structure.

In some examples, flexible hinge 32 or a portion of flexible hinge 32 may include a composite material, such as a filler within a matrix material. Example fillers include woven and non-woven polyesters, woven and non-woven polyester satins, cotton and cotton blend fabrics, microfiber fabrics, woven fabrics from thermoplastic fibers, non-woven fabrics from thermoplastic fibers, particles, pigments, or the like. The matrix material may include a thermoplastic or a thermoset elastomeric polyurethane.

Flexible hinge 32 includes first optical feature 44 formed in or on first hinge surface 36. As shown in FIG. 2, first optical feature 44 is substantially aligned with a second optical feature 46 formed in or on biodata page 34, such that first optical feature 44 and second optical feature 46 form an optical effect when viewed from above first hinge surface 36 (in the z-axis direction of FIG. 2). In some examples, as shown in FIG. 2, first optical feature 44 may be substantially directly above second optical feature 46 (in the z-axis direction of FIG. 2). In other examples, first optical feature 44 may be offset in the x-axis direction and/or y-axis direction of FIG. 2 from second optical feature 46, but optical properties of first optical feature 44 and/or second optical feature 46 may result in an optical effect produced by first optical feature 44 and second optical feature 46.

In some examples, registration or alignment between first optical feature 44 and second optical feature 46 may be in the x- and/or y-axis directions of FIG. 2. In other examples, registration or alignment between first optical feature 44 and second optical feature 46 may be in the x-, y-, and z-axis directions of FIG. 2, and first optical feature 44 and second optical feature 46 may be in substantial alignment or registration in all three axes in order to produce the optical effect.

Because first optical feature 44 and second optical feature 46 produce an optical effect when they are substantially aligned any change in relative positioning of first optical feature 44 relative to second optical feature 46 (in the direction(s) in which alignment is necessary to produce the optical effect) may destroy, distort, or otherwise change the optical effect. Hence, article 30 may be manufactured so that first optical feature 44 and second optical feature 46 are in substantial alignment and produce the desired optical effect. Then, if a tamperer or counterfeiter attempts to separate flexible hinge 32 from biodata page 34, the substantial alignment between first optical feature 44 and second optical feature 46 will be lost. Furthermore, attaching a different flexible hinge to biodata page 34 or attaching a different biodata page to flexible hinge 32 will be unlikely to result in the substantial alignment required to produce the optical effect. The lack of optical effect will be detectable and will indicate that the article has been tampered with.

FIG. 3 is a conceptual and schematic diagram illustrating another example of an article including a flexible hinge, a biodata page, and a composite security feature formed by a first optical feature formed on a surface of the flexible hinge and a second optical feature formed on or in the biodata page. Similar to article 30 of FIG. 2, article 50 of FIG. 3 includes a flexible hinge 52 and a biodata page 54. Flexible hinge 52 may be formed of any of the materials described with respect to flexible hinge 32 of FIG. 2. Similarly, biodata page 54 may be formed of any of the materials described with respect to biodata page 34 of FIG. 2.

Unlike biodata page 34, biodata page 54 includes a plurality of layers. The plurality of polymer layers may include, for example, a first layer 68, a second layer 70, and a third layer 72. In some examples, at least one of first layer 68, second layer 70, and third layer 72 may include a clear polymer layer, at least another of the first layer 68, second layer 70, and third layer 72 may include an opaque, e.g., white, polymer layer, and at least another of first layer 68, second layer 70, and third layer 72 may include a radiation sensitive material. For example, first layer 68 may include an opaque, e.g., white, polymer layer, second layer 70 may include a radiation sensitive material, and third layer 72 may include a clear polymer layer. In some examples, each of first layer 68, second layer 70, and third layer 72 may include a polymer, e.g., first layer 68 may include an opaque, e.g., white, polymer layer, second layer 70 may include laser-engravable polycarbonate, and third layer 72 may include a clear polymer layer. In such examples, the opaque, e.g., white, first layer 68 may improve visibility of images or text engraved in second layer 70, while the clear third layer 72 may allow viewing of the images or text engraved in second layer 70 through third layer 72. The opaque and clear polymer layers may be formed from any of a variety of polymers, including, for example, polycarbonate, polyethylene terephthalate (PET), and high density polyethylene (HDPE).

Second layer 70 may include a radiation sensitive material. The radiation sensitive material may include, for example, coatings and films of metallic, polymeric and semiconducting materials, as well as mixtures of these. As used herein, a material is “radiation sensitive” if, upon exposure to a given level of visible or other radiation, the appearance of the exposed material changes to provide a contrast with material that was not exposed to the radiation. The image created thereby could be the result of a compositional change within the material, a removal or ablation of the material, a phase change within the material, or a polymerization of the radiation sensitive material.

Examples of radiation sensitive metallic film materials include aluminum, silver, copper, gold, titanium, zinc, tin, chromium, vanadium, tantalum, and alloys of any one or more of these metals. These metals typically provide a contrast between metal exposed to radiation and metal not exposed to radiation due to the difference between the native color of the metal and a modified color of the metal after exposure to the radiation. The image, as noted above, may also be provided by ablation, or by the radiation heating the material until an image is provided by optical modification of the material. U.S. Pat. No. 4,743,526, for example, describes heating a metal alloy to provide a color change. The entire content of U.S. Pat. No. 4,743,526 is incorporated herein by reference.

In addition to metallic alloys, metallic oxides and metallic suboxides can be used as a radiation sensitive material. Materials in this class include oxide compounds formed from aluminum, iron, copper, tin and chromium. Non-metallic materials such as zinc sulfide, zinc selenide, silicon dioxide, indium tin oxide, zinc oxide, magnesium fluoride and silicon can also provide a color or contrast upon exposure to radiation, and can be used as the radiation sensitive material.

Multiple layers of thin film materials can also be used to provide unique radiation sensitive materials. These multilayer materials can be configured to provide a contrast change by the appearance or removal of a color or contrast agent. Exemplary constructions include optical stacks or tuned cavities that are designed to be imaged (e.g., by a change in color) by specific wavelengths of radiation. One example is described in U.S. Pat. No. 3,801,183, which discloses the use of cryolite/zinc sulphide (Na₃AlF₆/ZnS) as a dielectric mirror. The entire content of U.S. Pat. No. 3,801,183 is incorporated herein by reference. Another example is an optical stack composed of chromium/polymer (such as plasma polymerized butadiene)/silicon dioxide/aluminum where the thicknesses of the layers are in the ranges of 4 nm for chromium, between 20 nm and 60 nm for the polymer, between 20 nm and 60 nm for the silicon dioxide, and between 80 nm and 100 nm for the aluminum, and where the individual layer thicknesses are selected to provide specific color reflectivity in the visible spectrum. Thin film tuned cavities could be used with any of the single layer thin films previously discussed. For example, a tuned cavity could include an approximately 4 nm thick layer of chromium and a silicon dioxide layer of between about 100 nm and 300 nm, with the thickness of the silicon dioxide layer being adjusted to provide a colored image in response to specific wavelengths of radiation.

The radiation sensitive material also can include thermochromic materials. “Thermochromic” describes a material that changes color when exposed to a change in temperature. U.S. Pat. No. 4,424,990 describes examples of thermochromic materials, which include copper carbonate, copper nitrate with thiourea, and copper carbonate with sulfur-containing compounds such as thiols, thioethers, sulfoxides, and sulfones. U.S. Pat. No. 4,121,011 describes examples of other suitable thermochromic compounds, including hydrated sulfates and nitrides of boron, aluminum, and bismuth, and the oxides and hydrated oxides of boron, iron, and phosphorus. The entire contents of U.S. Pat. No. 4,424,990 and U.S. Pat. No. 4,121,011 are incorporated herein by reference.

In other examples, the radiation sensitive material may include a multilayer polymer construction. The multilayer polymer construction may include absorption characteristics tailored to heat one or more of the layers upon exposure to suitable radiation, which may change a birefringence of at least some of the layers, which changes a reflective characteristic of the multilayer polymer construction. Examples of such materials are described in U.S. Patent Application Publication No. 2011/0249334 to Merrill et al., entitled, “Internally Patterned Multilayer Optical Films with Multiple Birefringent Layers,” the entire content of which is incorporated herein by reference. The multilayer polymer construction may be fabricated using coextruding, casting, and orienting processes. Reference is made to U.S. Pat. No. 5,882,774 to Jonza et al., entitled, “Optical Film,” U.S. Pat. No. 6,179,949 to Merrill et al., entitled, “Optical Film and Process for Manufacture Thereof,” and U.S. Pat. No. 6,783,349 to Neavin et al., entitled “Apparatus for Making Multilayer Optical Films.” The entire contents of each of these patents are incorporated herein by reference. The multilayer polymer construction may be formed by coextrusion of the polymers as described in any of the aforementioned references. The polymers of the various layers are preferably chosen to have similar rheological properties, e.g., melt viscosities, so that they can be co-extruded without significant flow disturbances. Extrusion conditions are chosen to adequately feed, melt, mix, and pump the respective polymers as feed streams or melt streams in a continuous and stable manner. Temperatures used to form and maintain each of the melt streams may be chosen to be within a range that avoids freezing, crystallization, or unduly high pressure drops at the low end of the temperature range, and that avoids material degradation at the high end of the range.

In brief summary, the fabrication method may comprise: (a) providing at least a first and a second stream of resin corresponding to the first and second polymers to be used in the finished film; (b) dividing the first and the second streams into a plurality of layers using a suitable feedblock, such as one that comprises: (i) a gradient plate comprising first and second flow channels, where the first channel has a cross-sectional area that changes from a first position to a second position along the flow channel, (ii) a feeder tube plate having a first plurality of conduits in fluid communication with the first flow channel and a second plurality of conduits in fluid communication with the second flow channel, each conduit feeding its own respective slot die, each conduit having a first end and a second end, the first end of the conduits being in fluid communication with the flow channels, and the second end of the conduits being in fluid communication with the slot die, and (iii) optionally, an axial rod heater located proximal to said conduits; (c) passing the composite stream through an extrusion die to form a multilayer web in which each layer is generally parallel to the major surface of adjacent layers; and (d) casting the multilayer web onto a chill roll, sometimes referred to as a casting wheel or casting drum, to form a cast multilayer film. This cast film may have the same number of layers as the finished film, but the layers of the cast film are typically much thicker than those of the finished film. Furthermore, the layers of the cast film are typically all isotropic.

After cooling, the multilayer film can be drawn or stretched to produce the near-finished multilayer polymer construction, details of which can be found in the references cited above. The drawing or stretching accomplishes two goals: it thins the layers to their desired final thicknesses, and it orients the layers such that at least some of the layers become birefringent. The orientation or stretching can be accomplished along the cross-web direction (e.g. via a tenter), along the downweb direction (e.g. via a length orienter), or any combination thereof, whether simultaneously or sequentially. If stretched along only one direction, the stretch can be “unconstrained” (wherein the multilayer construction is allowed to dimensionally relax in the in-plane direction perpendicular to the stretch direction) or “constrained” (wherein the multilayer construction is constrained and thus not allowed to dimensionally relax in the in-plane direction perpendicular to the stretch direction). If stretched along both in-plane directions, the stretch can be symmetric, i.e., equal along the orthogonal in-plane directions, or asymmetric. Alternatively, the multilayer construction may be stretched in a batch process. In any case, subsequent or concurrent draw reduction, stress or strain equilibration, heat setting, and other processing operations can also be applied to the multilayer construction.

In some cases, the natural or inherent absorptivity of one, some, or all of the constituent polymer materials that make up the multilayer optical film may be utilized for the absorptive heating procedure. For example, many polymers that are low loss over the visible region have substantially higher absorptivity at certain ultraviolet wavelengths. Exposing portions of the film to light of such wavelengths may be used to selectively heat such portions of the film.

In other cases, absorbing dyes, pigments, or other agents can be incorporated into some or all of the individual layers of the multilayer optical film to promote absorptive heating as mentioned above. In some cases, such absorbing agents are spectrally selective, whereby they absorb in one wavelength region but not in another. For example, an absorbing agent that absorbs at infrared or ultraviolet wavelengths but not substantially at visible wavelengths may be used. Further, an absorbing agent may be incorporated into one or more selected layers of a film. For example, the film may comprise two distinct microlayer packets separated by an optically thick layer such as a protective boundary layer (PBL), a laminating adhesive layer, one or more skin layers, or the like, and an absorbing agent may be incorporated into one of the packets and not the other, or may be incorporated into both packets but at a higher concentration in one relative to the other.

A variety of absorbing agents can be used. For optical films operating in the visible spectrum, dyes, pigments, or other additives that absorb in the ultraviolet and infrared (including near infrared) regions may be used. In some cases it may be advantageous to select an agent that absorbs in a spectral range for which the polymer materials of the film have a substantially lower absorption. By incorporating such an absorbing agent into selected layers of a multilayer optical film, directed radiation can preferentially deliver heat to the selected layers rather than throughout the entire thickness of the film. Exemplary absorbing agents may be melt extrudable so that they can be embedded into a selected layer set of interest. To this end, the absorbers are preferably reasonably stable at the processing temperatures and residence times required for extrusion. For further information on suitable absorbing agents, reference is made to U.S. Pat. No. 6,207,260, to Wheatley et al., entitled “Multicomponent Optical Body,” the entire content of which is incorporated herein by reference.

Another radiation sensitive material includes laser-engravable polycarbonate. Laser-engravable polycarbonate can include clear polycarbonate containing an additive that absorbs radiation of a specific wavelength as heat and chars the polycarbonate. For example, some laser engravable polycarbonate may include an additive that absorbs infrared energy, such as energy with a wavelength of 1064 nm. Charring of the polycarbonate causes it to darken, which provides contrast with the surrounding clear polycarbonate.

As shown in FIG. 3, flexible hinge 52 includes a first optical feature 64 formed on first surface 56 of flexible hinge 52. First optical feature 64 may include a plurality of lenses or lenticulates. In some examples, first optical feature 64 may include a plurality of parallel lenticular or cylindrical lens, such as those described in U.S. Pat. No. 4,765,656 and European Patent No. 1,322,480. In some examples, first optical feature 64 may include a plurality of microlenses, such as those described in U.S. Pat. No. 5,712,731 and U.S. Patent Application Publication 2009/0122412. In some examples, first optical feature 64 may include a plurality of microlenses, such as those described in Patent Cooperation Treaty Publication No. 2012/162041. The entire contents of U.S. Pat. No. 4,765,656, European Patent No. 1,322,480, U.S. Pat. No. 5,712,731, and U.S. Patent Application Publication 2009/0122412 are incorporated herein by reference.

FIGS. 4-6 are conceptual and schematic diagrams illustrating examples of a flexible hinge including a plurality of microlenses. For example, FIG. 4 illustrates a flexible hinge 80 including “exposed lens” type of microlenses. The plurality of microlenses includes a monolayer of transparent microspheres 82 that are partially embedded in a binder layer 84, which may be a polymeric material, e.g., the polymeric material from which flexible hinge 80 is formed. Microspheres 82 are transparent both to the wavelengths of radiation that may be used to image the layer of material, as well as to the wavelengths of light in which the optical effect formed by first optical feature 64 and second optical feature 66 (FIG. 3) will be viewed. Each of transparent microspheres 82 may have a focal point that is configured to lie within second layer 70 (FIG. 3).

As another example, FIG. 5 a flexible hinge 86 including “embedded-lens” type of microlenses, in which the microsphere lenses 88 are embedded between a transparent protective overcoat 92, which is typically a polymeric material, and a transparent spacer layer 90, which is also typically a polymeric material. This type of sheeting is described in greater detail in U.S. Pat. No. 3,801,183, and is presently available from 3M under the designation Scotchlite 3290 series Engineer grade retroreflective sheeting. Another suitable type of microlens sheeting is referred to as encapsulated lens sheeting, an example of which is described in U.S. Pat. No. 5,064,272, and presently is available from 3M under the designation Scotchlite 3870 series High Intensity grade retroreflective sheeting.

FIG. 6 illustrates another flexible hinge 94 that includes a plurality of microlenses. Flexible hinge 94 includes a transparent plano-convex or aspheric base sheet having first and second broad faces, the second face 96 being substantially planer and the first face having an array of substantially hemi-spheroidal or hemi-aspheroidal microlenses 98. The shape of the microlenses and thickness of the base sheet are selected such that collimated light incident to the array is focused beyond second face 96. Sheeting of this kind is described in, for example, U.S. Pat. No. 5,254,390, and is presently available from 3M under the designation 2600 series 3M Secure Card receptor.

In some examples, the plurality of microlenses may have a uniform refractive index of between 1.5 and 3.0 over the visible and infrared wavelengths. Suitable microlens materials will have minimal absorption of visible light, and in embodiments in which radiation from an energy source is used to image a radiation sensitive material in second layer 70, the materials from which the plurality of microlenses are formed should exhibit minimal absorption of the radiation as well.

The refractive power of the microlenses, whether the microlenses are discrete or replicated, and regardless of the material from which the microlenses are made, may be such that the light incident upon the refracting surface will refract and focus within second layer 70. The microlenses may form a demagnified real image at the appropriate position in second layer 70. Demagnification of the image by approximately 100 to 800 times is particularly useful for forming images that have good resolution.

Each of plurality of microspheres 82 may have a diameter between about 15 micrometers and about 275 micrometers, though other sized microspheres 82 may be used. Good composite image resolution can be obtained by using microspheres 82 having diameters in the smaller end of the aforementioned range for composite images that are to appear to be spaced apart from the microsphere layer by a relatively short distance, and by using larger microspheres 82 for composite images that are to appear to be spaced apart from the microsphere layer by larger distances. Other microlens, such as plano-convex, cylindrical, spherical or aspherical microlenses having lenslet dimensions comparable to those indicated for the microspheres 82, can be expected to produce similar optical results.

Returning now to FIG. 3, each of the plurality of lenses defines a focal point. For a set of the lenses, the focal points lie within second layer 70 (when flexible hinge 32 is attached to surface 60 of second layer 70), which may include a radiation sensitive material. As shown in FIG. 3, within second layer 70 is formed a plurality of images 66, which constitute a second optical feature. Each of the plurality of images 66 is formed at a position coincident with the focal point of a respective one of the set of lenses. In other words, the plurality of images 66 is substantially aligned with the set of lenses.

The plurality of images 66 may be formed within second layer 70 using a radiation source which is configured to modify the radiation sensitive material in second layer 70. Any energy source providing radiation of the desired intensity and wavelength can be used with the method of the present invention. Devices capable of providing radiation having a wavelength of between 200 nm and 11 micrometers may be useful in combination with radiation sensitive materials described herein. Examples of high peak power radiation sources include excimer flashlamps, passively Q-switched microchip lasers, Q-switched Neodymium doped-yttrium aluminum garnet (abbreviated Nd:YAG), Q-switched Neodymium doped-yttrium lithium fluoride (abbreviated Nd:YLF), and Q-switched Titanium doped-sapphire (abbreviated Ti:sapphire) lasers. These high peak power sources may be particularly useful with a radiation sensitive material in second layer 70 that forms images through ablation—the removal of material or in multiphoton absorption processes. Other examples of useful radiation sources include devices that give low peak power such as laser diodes, ion lasers, non Q-switched solid state lasers, metal vapor lasers, gas lasers, arc lamps and high power incandescent light sources. These sources may be particularly useful when the radiation sensitive material in second layer 70 is imaged by a non-ablative method.

The energy from the radiation source is directed toward the set of lenses in first optical feature 64 and controlled to give a highly divergent beam of energy. For energy sources in the ultraviolet, visible, and infrared portions of the electromagnetic spectrum, the light is controlled by appropriate optical elements. In one embodiment, the optical elements may direct light toward the set of lenses in first optical feature 64 with appropriate divergence or spread so as to irradiate the set of microlenses and thus second layer 70 at the desired angles. In some examples, second optical feature 66 may be obtained by using light spreading devices with numerical apertures (defined as the sine of the half angle of the maximum diverging rays) of greater than or equal to 0.3. Light spreading devices with larger numerical apertures may produce composite images having a greater viewing angle, and a greater range of apparent movement of the image.

In some examples, second optical feature 66 may be formed by directing collimated light from a laser through a lens toward the set of microlenses with focal points within second layer 70. To create a floating image the light is transmitted through a diverging lens with a high numerical aperture (NA) to produce a cone of highly divergent light. As used herein, a high NA lens is a lens with a NA equal to or greater than 0.3. The second hinge side 58 is positioned away from the high NA lens, so that the axis of the cone of light (the optical axis) is substantially perpendicular to the plane second layer 70 (e.g., the optical axis is substantially parallel to the z-axis of FIG. 3).

Because each microlens occupies a unique position relative to the optical axis, the light impinging on each microlens will have a unique angle of incidence relative to the light incident on each other microlens. Thus, the light will be transmitted by each microlens to a unique position within second layer 70, and produce a unique image, represented by the individual boxes of second optical feature 66.

A single light pulse produces only a single imaged dot within second layer 70, so to provide an image within second layer 70, multiple pulses of light are used to create that image out of multiple imaged dots. For each light pulse, the optical axis is located at a new position relative to the position of the optical axis during the previous pulse. These successive changes in the position of the optical axis relative to the microlenses results in a corresponding change in the angle of incidence upon each microlens, and accordingly in the position of the imaged dot created in second layer 70 by that pulse. As a result, the incident light focusing within second layer 70 by the microlenses images a selected pattern within second layer 70. Because the position of each microlens is unique relative to every optical axis, the image formed in the radiation sensitive material for each microlens will be different from the image associated with each other microlens.

Another method for forming floating composite images uses a lens array to produce the highly divergent light to image the radiation sensitive material within second layer 70. The lens array may include multiple small, high NA lenses arranged in a planar geometry. When the array is illuminated by a light source, the array produces multiple cones of highly divergent light, each individual cone being centered upon a corresponding lens in the array. The physical dimensions of the array are chosen to accommodate the largest lateral size of a composite image. By virtue of the size of the array, the individual cones of energy formed by the lenses will expose the radiation sensitive material in second layer 70 as if an individual lens was positioned sequentially at all points of the array while sequentially receiving pulses of light. The selection of which lenses receive the incident light occurs by the use of a reflective mask. This mask will have transparent areas corresponding to sections of the second optical feature 66 that are to be exposed and reflective areas where the image should not be exposed.

By having the mask fully illuminated by the incident energy, the portions of the mask that allow energy to pass through will form many individual cones of highly divergent light outlining the floating image as if the image was traced out by a single lens. As a result, only a single light pulse is needed to form the entire composite image in the microlens sheeting. Alternatively, in place of a reflective mask, a beam positioning system, such as a galvometric x-y scanner, can be used to locally illuminate the lens array and trace the composite image on the array. Since the energy is spatially localized with this technique, only a few lenses in the array may be illuminated at any given time. Those lenslets that are illuminated will provide the cones of highly diverging light needed to expose the radiation sensitive material within second layer 70 to form the second optical feature 66.

The lens array itself can be fabricated from discrete lenslets or by an etching process to produce a monolithic array of lenses. Materials suitable for the lenses are those that are non-absorbing at the wavelength of the incident energy. The individual lenses in the array preferably have numerical apertures greater than 0.3 and diameters greater than 30 micrometers but less than 10 mm. These arrays may have antireflection coatings to reduce the effects of back reflections that may cause internal damage to the lens material. In addition, single lenses with an effective negative focal length and dimensions equivalent to the lens array may also be used to increase the divergence of the light leaving the array. Shapes of the individual lenslets in a monolithic array are chosen to have a high numerical aperture and provide a large fill factor of approximately greater than 60%.

As described above, when second optical feature 66 is viewed from above first optical feature 64 (e.g., in the z-axis direction of FIG. 3), the combination may provide an optical effect in which the image of second optical feature 66 appears to float above, below, and/or within the plane of second layer 70. However, this effect may only occur when first optical feature 64 is substantially aligned with (e.g., aligned or nearly aligned with) second optical feature 66, such that the respective lenses of the set of lenses with focal points lying within second layer 70 are aligned with the respective images of second optical feature 66. In some examples, a misalignment of as little as about 20 micrometers (or as little as 10 micrometers or as little as 4 micrometers) may render the floating image optical effect distorted, damaged, or rendered invisible.

Other microlens-based optical phenomena can be used to add a sense of motion and changing spatial content to composite images. For example, U.S. Pat. No. 5,712,731 to Drinkwater, U.S. Patent Application Publication No. 2009/0034082 to Commander et al., and U.S. Patent Application Publication No. 2007/0177131 to Hansen describe imaging processes for security applications, based on Moiré magnification, using either high-resolution printing or embossing to produce a microimage array behind a lenslet array. This basic concept has also been demonstrated in U.S. Patent Application Publication No. 2009/0122412 to Steenblik et al. to produce images for overt security applications that appear to float above or below a substrate containing a lens array. This technology also requires substantial alignment of the lenslet array to the printed microimages; for the technologies described in Steenblick, misalignment on the order of 10 microns can cause noticeable differences in image quality or size. The entire contents of U.S. Pat. No. 5,712,731, U.S. Patent Application Publication No. 2009/0034082, U.S. Patent Application Publication No. 2007/0177131, and U.S. Patent Application Publication No. 2009/0122412 are incorporated herein by reference.

Hence, if flexible hinge 52 is moved relative to biodata page 54, the optical effect may be distorted, damaged, or rendered invisible. This may make replacement of flexible hinge 52 with a different hinge or replacement of biodata page 54 with a different biodata page, without affecting the floating image optical effect, more difficult, which may in turn make successful (e.g., undetected) tampering with article 50 more difficult.

FIG. 7 is a conceptual and schematic diagram illustrating another example of an article 100 including a flexible hinge 102, a biodata page 104, and a composite security feature formed by a first optical feature 106 formed on a first hinge surface 108 of the flexible hinge 102 and a second optical feature 110 formed on a surface of a layer within biodata page 104. Article 100 may be similar to or substantially the same as article 30 of FIG. 2 and/or article 50 of FIG. 3, aside from the differences noted herein.

Flexible hinge 102 includes a first optical feature 106 that includes a plurality of lenses, the same as or substantially similar to flexible hinge 52 of FIG. 3. Each of the plurality of lenses of first optical feature 106 defines a focal point. For a set of the plurality of lenses, which may be at least one and may be all of the plurality of lenses, the focal point lies within biodata page 104. In the example shown in FIG. 7, focal points of the first set of lenses 122 lie within biodata page 104, and focal points of a second set of lenses 124 lie outside of biodata page 104. In particular, in the example shown in FIG. 7, when second hinge surface 112 is attached to surface 114 of second layer 118, the focal point for each of the first set of lenses 122 lies approximately at the interface between first layer 116 and second layer 118 of biodata page 104.

Second optical feature 110 is formed at a location substantially aligned with or substantially in registration with first optical feature 106. In the example of FIG. 7, second optical feature 110 includes a plurality of color images. The plurality of color images may be formed on a surface of first layer 116 and/or second layer 118 prior to first layer 116 being attached to second layer 118. For example, flexible hinge 102 may be attached to second layer 118 and third layer 120. Second optical feature 100 then may be formed by placing a colored material in close contact with surface 119 of second layer 118, and exposing the colored material to radiation through one or more of the lenses of first set of lenses 122. The radiation heats the colored material and causes the colored material to adhere to or be incorporated into surface 119 of second layer 118. This process may be repeated for a plurality of colors at a plurality of locations to form a colored image on surface 119 of second layer 118 that can be viewed through first set of lenses 122. As shown in FIG. 7, each of the plurality of color images may substantially lie within a focal point of a respective one of the set of lenses. In this way, similar to the example shown in FIG. 3, the plurality of color images may form a floating image when viewed through the set of lenses in first optical feature 106. The color floating image may appear to float above, below, or within the plane of the interface between first layer 116 and second layer 118.

In some examples, first layer 116 may include a substantially opaque layer, e.g., a white layer of polycarbonate, which may increase contrast of the floating image formed by first optical feature 106 and second optical feature 110. One or both of second layer 118 and third layer 120 may be substantially clear. In some examples, third layer 120 includes a layer of substantially clear polycarbonate, and second layer 118 includes a layer of laser engravable polycarbonate, which is substantially clear for the portion of second layer 118 overlying second optical feature 110. In this way, second layer 118 may have personal information engraved within the layer 118 at locations other than over second optical feature 110 while allowing second optical feature 110 to be viewed from above first optical feature 106 (e.g., in the z-axis direction of FIG. 7, where orthogonal x-y-z axes are shown for ease of description only).

When second optical feature 110 is viewed from above first optical feature 106 (e.g., in the z-axis direction of FIG. 3), the combination may provide an optical effect in which the image of second optical feature 110 appears to float above, below, and/or within the plane of the interface between first layer 116 and second layer 118. However, this effect may only occur when first optical feature 106 is substantially aligned with (e.g., aligned or nearly aligned with) second optical feature 110, such that the respective lenses of first set of lenses 122 are substantially aligned with the respective images of second optical feature 110. In some examples, a misalignment of as little as about 20 micrometers (or as little as 10 micrometers or as little as 4 micrometers) may render the floating image optical effect distorted, damaged, or rendered invisible. Hence, if flexible hinge 102 is moved relative to biodata page 104, the optical effect may be distorted, damaged, or rendered invisible. This may make replacement of flexible hinge 102 with a different hinge or replacement of biodata page 104 with a different biodata page, without affecting the floating image optical effect, more difficult, which may in turn make successful (e.g., undetected) tampering with article 100 more difficult.

FIG. 8 is a conceptual and schematic diagram illustrating another example of an article 130 including a flexible hinge 132, a biodata page 134, and a composite security feature formed by a first optical feature 136 formed on a first hinge surface 138 of the flexible hinge 132 and a second optical feature 140 formed on a surface of a layer within biodata page 134. Article 130 may be similar to or substantially the same as article 30 of FIG. 2, article 50 of FIG. 3, and/or article 100 of FIG. 7, aside from the differences noted herein.

Unlike flexible hinges 52 and 102, flexible hinge 132 does not include a plurality of lenses formed on first hinge surface 138. Instead, flexible hinge 132 includes a diffractive optical element 136 formed on first hinge surface 138. Diffractive optical element 136 is a first optical feature formed on first hinge surface 138. Diffractive optical element 136 may include, for example, a diffraction grating or another diffraction-causing optical feature.

As shown in FIG. 8, diffractive optical element 136 is substantially aligned with or substantially in registration with second optical feature 140. Second optical feature 140 is formed within biodata page 134. For example, second optical feature 140 may be formed on a surface of first layer 146 and/or a surface of second layer 148 before first layer 146 and second layer 148 are attached to each other. Second optical feature 140 may be a pattern, such as an image, formed on the surface of first layer 146 and/or the surface of second layer 148. In some examples, second optical feature 140 may be formed using a printing process, such as, for example, inkjet printing, screen printing, thermal transfer printing, or the like.

Light passing through diffractive optical element 136 and impinging upon second optical feature 140 may result in an optically variable device, e.g., the appearance of the image changes as a viewing angle of the image through diffractive optical element 136 changes. This optically variable device may change when an alignment between diffractive optical element 136 and second optical feature 140 changes. Hence, if flexible hinge 132 is moved relative to biodata page 134, the optically variable device may change or may no longer function. This may make replacement of flexible hinge 132 with a different hinge or replacement of biodata page 134 with a different biodata page, without affecting the optical effect, more difficult, which may in turn make successful (e.g., undetected) tampering with article 130 more difficult.

FIGS. 9A and 9B are conceptual and schematic diagrams illustrating another example of an article 160 including a flexible hinge 162, a biodata page 164, and a composite security feature formed by a first optical feature 166 formed on a first hinge surface 168 of the flexible hinge 162 and a second optical feature 170 formed on a surface 172 of biodata page 164. The composite security feature formed by first optical feature 166 and second optical feature 170 may include a composite image formed by a first image formed by first optical feature 166 and a second image formed by second optical feature 170. Article 130 may be similar to or substantially the same as article 30 of FIG. 2, article 50 of FIG. 3, article 100 of FIG. 7, and/or article 130 of FIG. 8, aside from the differences noted herein.

Flexible hinge 162 includes first hinge surface 168, on which first optical feature 166 is formed. First hinge surface 168 is attached to biodata page surface 172. As shown in FIG. 9A, biodata page surface 172 is substantially planar. In contrast to the examples shown in FIGS. 2, 3, 6, and 7, biodata page 164 does not include a stepped portion, such that second hinge surface 174 is substantially coplanar with biodata page surface 172. Instead, in the examples of FIGS. 9A and 9B, second hinge surface 174 is not substantially coplanar with biodata page surface 172. Such an arrangement, where a top surface of the flexible hinge is not substantially coplanar with a top surface of the biodata page, may be used in combination with any of the other examples shown and described herein. Conversely, in some implementations, biodata page 164 may include a stepped portion, such that when flexible hinge 162 is attached to biodata page 164, second hinge surface 174 is substantially coplanar with biodata page surface 172.

Additionally or alternatively, although flexible hinge 162 is illustrated in FIGS. 9A and 9B as covering and being attached to only a portion of biodata page surface 172, in other examples, flexible hinge 162 may cover and be attached to substantially all of biodata page surface 172. Such an arrangement may be used in combination with any of the other examples shown and described herein.

In the example shown in FIGS. 9A and 9B, first optical feature 166 may include a pattern, such as an image. The image may be a repeating or non-repeating pattern, picture, text, or any other visual representation. In some examples, first optical feature 166 may be formed on or in first hinge surface 168 using a printing process, such as, for example, inkjet printing, screen printing, thermal transfer printing, or the like.

Biodata page 164 includes a first layer 176 and a second layer 178. Although not shown in FIGS. 9A and 9B, in other examples, biodata page 164 may include additional layers. Additionally or alternatively, one or both of first layer 176 and second layer 178 may be a bilayer formed of two sublayers. For example, first layer 176 may be a bilayer formed of a sublayer of white polycarbonate and a sublayer of clear polycarbonate. As another example, second layer 176 may be a bilayer formed of a sublayer of laser engravable polycarbonate and a layer of clear polycarbonate.

Second layer 178 includes a second optical feature 170 formed on biodata page surface 172. In the example shown in FIGS. 9A and 9B, second optical feature 170 may include a pattern, such as an image. The image may be a repeating or non-repeating pattern, picture, text, or any other visual representation. In some examples, second optical feature 170 may be formed on or in biodata page surface 172 using a printing process, such as, for example, inkjet printing, screen printing, thermal transfer printing, or the like.

As shown in FIGS. 9A and 9B, first optical feature 166 and second optical feature 170 are substantially aligned or in registration with each other. Together, first optical feature 166 and second optical feature 170 form a composite optical effect, such as an image. In the example illustrated in FIGS. 9A and 9B, first optical feature 166 includes a plurality of lines lying substantially parallel to each other and substantially in the x-axis direction (where orthogonal x-y-z axes are shown in FIGS. 9A and 9B for description only). Second optical feature 170 includes a plurality of lines lying substantially parallel to each other and substantially in the y-axis direction. Together, first optical feature 166 and second optical feature 170 form a cross-hatched pattern. Other images also may be formed by first optical feature 166 and second optical feature 170 in other examples, such as an image where a first portion of the image is formed by first optical feature 166 and a second portion of the image is formed by second optical feature 170.

In some examples, at least a portion of first optical feature 166 and/or second optical feature 170 may be formed of a radiation sensitive material, such as a radiation sensitive metallic film, a radiation sensitive metallic oxide or suboxide, a thermochromic material, a multilayer material, or a laser engravable polycarbonate, as described above. This may allow marking of the radiation sensitive material using incident radiation from a radiation source, e.g., after attaching flexible hinge 162 to biodata page 164.

As shown in FIG. 8, first hinge surface 168 is attached to biodata page surface 172, which created contact between first optical feature 166 and second optical feature 170. In some examples, the adhesion between first hinge surface 168 and biodata page surface 172 may be sufficiently strong so that if flexible hinge 162 is separated from biodata page 164, it is likely that a portion of flexible hinge 162 will remain attached to biodata page 164 or vice versa. Alternatively, if thermal processing is used to separate flexible hinge 162 from biodata page 164, the thermal processing may cause flexible hinge 162 to deform, marring first optical feature 166. In any case, because the composite optical image is formed by first optical feature 166 and second optical feature 170, if flexible hinge 162 is moved relative to biodata page 164, the composite optical image may be distorted or destroyed. This may make replacement of flexible hinge 162 with a different hinge or replacement of biodata page 164 with a different biodata page, without affecting the optical effect, more difficult, which may in turn make successful (e.g., undetected) tampering with article 160 more difficult.

In some examples, a flexible hinge may include additional security features, in addition to the composite optical effect formed by a first optical feature on the flexible hinge and a second optical feature in or on the biodata page. For example, a flexible hinge may include one or more additional security features such as an radio frequency identification (RFID) chip; one or more fluorescent dyes; one or more taggants; one or more surface structures, which may form graphics, text, diffractive elements, and/or refractive elements; one or more embedded structures; one or more polarizing components; a color-shifting film; a security thread; guilloche printing; color-shifting ink printing; or the like. FIG. 10 is a conceptual and schematic diagram illustrating an example of an article 180 including a flexible hinge 182, a biodata page 184, and a composite security feature formed by a first optical feature 186 formed on a surface 188 of the flexible hinge 182 and a second optical feature 190 formed on or in the biodata page 184. Additionally, flexible hinge 182 includes a third optical feature 192, which interacts with first optical feature 186 to form a second security feature within flexible hinge 182. Article 180 may be similar to or substantially the same as article 30 of FIG. 2, article 50 of FIG. 3, article 100 of FIG. 7, article 130 of FIG. 8, and/or article 160 of FIGS. 9A and 9B, aside from the difference described herein.

First optical feature 186 includes a plurality of lenses. As shown in FIG. 10, in some examples, the plurality of lenses may be divided into a first set of lenses 194 and a second set of lenses 196. Each of the lenses in first set of lenses 194 defines a focal point lying within second layer 204 of biodata page. Each of the lenses in second set of lenses 196 defines a focal point lying outside of biodata page 184. In other examples, the plurality of lenses may be divided into more than two sets, where each of the lenses within a set have their focal points lying in a similar position (e.g., within or at a surface of a selected layer).

At each of the focal points of first set of lenses 194 are formed respective portions of second optical feature 190. As described with respect to article 50 of FIG. 3, second layer 204 may be formed of a radiation sensitive material, including, but not limited to, laser engravable polycarbonate. Second optical feature 190 may be formed by exposing portions of second layer 204 to radiation through first set of lenses 194, which forms the respective portions of second optical feature 190. When viewed through first set of lenses 194, second optical feature 190 may appear to float above, below, or within the plane of second layer 204, and may appear to move as the viewing axis relative to first set of lenses 194 changes.

The focal points of each of second set of lenses 194 lie substantially at second surface 198 of flexible hinge 182. At each of the focal points of second set of lenses 196 is formed one of a plurality of color images, which together form third optical feature 192. The plurality of color images may be formed on second hinge surface 198 before or after flexible hinge 182 is attached to biodata page 184. For example, the plurality of color images may be formed by placing a colored material in close contact with second hinge surface 198, then exposing the colored material to radiation through one or more of second set of lenses 194. The radiation heats the colored material and causes the colored material to adhere to or be incorporated into second hinge surface 198. This process may be repeated for a plurality of colors at a plurality of locations to form a colored image on second hinge surface 198 that can be viewed through second set of lenses 196.

Because the color images lie substantially at focal points of second set of lenses 196, the plurality of color images may form a floating image when viewed through second set of lenses 196. The color floating image may appear to float above, below, or within the plane of the second hinge surface 198, and may appear to move as the viewing axis relative to second set of lenses 196 changes.

Although FIG. 10 illustrates each of first set of lenses 194 as defining a different focal distance than each of second set of lenses 196, in other examples, each of the lenses in first set of lenses 194 and second set of lenses 196 may define a substantially similar focal length.

Alternatively, second optical feature 190 may be composed of two or more discrete images, each of the discrete images viewable at a different observation angle through lenses 194. The two or more discrete images of second optical feature 190 may be formed by directing radiation through first set of lenses 194 at a first angle (e.g., relative to first hinge surface 188) to create a first discrete image, then by directing radiation through first set of lenses 194 at a second angle (e.g. relative to first hinge surface 188) to create a second discrete image, continuing at different angles for each discrete image. After formation, the optical effect produced by first set of lenses 194 and the discrete images composing second optical feature 190 may be viewed through first set of lenses 194 at the first viewing angle relative to first hinge surface 188 to view the first discrete image of second optical feature 190, then viewing optical feature 190 at the second angle to view the second discrete of second optical feature 190.

The optical effect produced by first set of lenses 194 and second optical feature 190 may make tampering by removal of flexible hinge 182 from biodata page 184 more difficult, e.g., without distorting or destroying the optical effect, due to a lack of substantial registration or alignment between first set of lenses 194 and second optical feature 190 after tampering. Additionally, any tampering that includes moving flexible hinge 182 relative to biodata page 184 may be indicated by a change in the optical effect or a lack of the optical effect, due to misalignment of first set of lenses 194 and second optical feature 190 after tampering. The optical effect produced by second set of lenses 196 and third optical feature 192 may hinder an attempt at tempering by cutting through flexible hinge 182 to separate a portion of flexible hinge 182 from biodata page 184 while leaving first set of lenses 194 attached to biodata page 184.

FIG. 11 is a flow diagram that illustrates an example technique for forming an article including a flexible hinge and biodata page in accordance with some examples of this disclosure. The technique of FIG. 11 will be described with reference to article 100 of FIG. 7 for purposes of illustration only, and may be used to create other assemblies, such as article 130 of FIG. 8, article 160 of FIGS. 9A and 9B, or other assemblies including features in accordance with this disclosure.

The technique of FIG. 11 includes forming flexible hinge 102, including first optical feature 106 in first hinge surface 108 (212). Flexible hinge 102 may be formed from any of a variety of techniques, including, for example, extrusion, reactive extrusion, solvent casting, reactive casting, molding, or the like. In some examples, forming flexible hinge 102 includes a plurality of steps, including, for example, forming a sheet of polymeric material followed by at least partially embedding microspheres in the surface of the sheet of polymeric material, and may include forming additional layers over the at least partially embedded microspheres to encapsulate the microspheres within a film. In other examples, forming flexible hinge 102 may include casting or molding the microlenses directly into the flexible hinge 102, or may include forming a sheet of polymeric material followed by removing some of the material to form the microlenses, e.g., using thermal ablation.

In other examples, such as when first optical feature 106 includes a feature other than a plurality of microlenses, the first optical feature 106 may be formed using a different process. For example, an image may be formed on a surface of the flexible hinge (for forming first optical feature 166 of FIGS. 9A and 9B) or a diffractive optical element 136 (FIG. 8), such as an diffraction grating, may be formed in a surface of the flexible hinge by casting, molding, removal of material, or the like. As another example, the first optical feature 106 may be formed as a separate structure from flexible hinge 102 and may be attached to flexible hinge 102 using an adhesive.

The technique of FIG. 11 also includes forming a biodata page 104 including a second optical feature 110 (214). In the example of FIG. 7, each of first layer 116, second layer 118, and/or third layer 120 of biodata page 104 may be formed by extruding, casting, molding, or the like. The plurality of color images then may be formed on a surface of first layer 116 and/or second layer 118. In some examples, third layer 120 may be formed to a size that is smaller than first layer 116 and second layer 118, e.g., so that when first layer 116, second layer 118, and third layer 120 are assembled, surface 114 of second layer 118 is exposed. In other examples, material may be removed from third layer 120 after initially forming third layer 120 to result in a necessary size to expose surface 114 of second layer 118.

The technique of FIG. 11 further includes attaching flexible hinge 102 to biodata page 104 with substantial alignment between first optical feature 106 and second optical feature 110 (214). In some examples, first layer 116, second layer 118, third layer 120, and flexible hinge 102 may be assembled in substantial alignment, e.g., with perimeters of first layer 116 and second layer 118 aligned, and with edges of third layer 120 and flexible hinge 102 aligned with each other and with edges of first layer 116 and second layer 118 along portions of the perimeters where alignment is desired. Further, first optical feature 106 (e.g., first set of lenses 122) and second optical feature 110 may be substantially aligned or substantially in registration with each other, such that focal points of respective ones of first set of lenses 122 coincide with respective ones of the plurality of color images in second optical feature 110.

Once flexible hinge 102 and the layers 116, 118, and 120 of biodata page 104 are aligned, the respective layers may be attached to each other using, for example, lamination, an adhesive, ultrasonic welding, solvent welding, thermal welding, hot gas welding, contact welding, friction welding, or the like.

In other examples, first layer 116, second layer 118, and third layer 120 may first be assembled and attached to each other, e.g., by laminating, adhering, or welding first layer 116 and second layer 118, and second layer 118 and third layer 120. In a separate step, flexible hinge 102 may be assembled with biodata page 104 (with first optical feature 106 being substantially aligned with second optical feature 110), and second hinge surface 112 may be attached to surface 114 of second layer 118. Second hinge surface 112 may be attached to surface 114 using, for example, lamination, an adhesive, ultrasonic welding, solvent welding, thermal welding, hot gas welding, contact welding, friction welding, or the like.

FIG. 12 is a flow diagram that illustrates another example technique for forming an article including a flexible hinge and biodata page in accordance with some examples of this disclosure. The technique of FIG. 11 will be described with reference to article 50 of FIG. 3 for purposes of illustration only, and may be used to create other assemblies, such as article 180 of FIG. 10 or other assemblies including features in accordance with this disclosure.

The technique of FIG. 12 includes forming flexible hinge 52, including first optical feature 64 in first hinge surface 56 (212). Flexible hinge 52 may be formed from any of a variety of techniques, including, for example, extrusion, reactive extrusion, solvent casting, reactive casting, molding, or the like. In some examples, forming flexible hinge 52 includes a plurality of steps, including, for example, forming a sheet of polymeric material followed by at least partially embedding microspheres in the surface of the sheet of polymeric material. In other examples, forming flexible hinge 52 may include casting or molding the microlenses directly into the flexible hinge 52, or may include forming a sheet of polymeric material followed by removing some of the material to form the microlenses, e.g., using thermal ablation.

The technique of FIG. 12 also includes attaching flexible hinge 52 to biodata page 54 (218). In some examples, first layer 68, second layer 70, third layer 72, and flexible hinge 52 may be assembled in substantial alignment, e.g., with perimeters of first layer 68 and second layer 70 aligned, and with edges of third layer 72 and flexible hinge 52 aligned with each other and with edges of first layer 68 and second layer 70 along portions of the perimeters where alignment is desired.

Once flexible hinge 52 and the layers 68, 70, and 72 of biodata page 54 are aligned, the respective layers may be attached to each other using, for example, lamination, an adhesive, ultrasonic welding, solvent welding, thermal welding, hot gas welding, contact welding, friction welding, or the like.

In other examples, first layer 68, second layer 70, and third layer 72 may first be assembled and attached to each other, e.g., by laminating, adhering, or welding first layer 68 and second layer 70, and second layer 70 and third layer 72. In a separate step, flexible hinge 52 may be assembled with biodata page 54, and second hinge surface 58 may be attached to surface 60 of second layer 70. Second hinge surface 58 may be attached to surface 60 using, for example, lamination, an adhesive, ultrasonic welding, solvent welding, thermal welding, hot gas welding, contact welding, friction welding, or the like.

The technique of FIG. 12 further includes forming second optical feature 66 in biodata page 54 (220). For example, when second optical feature 66 includes a plurality of images, as in the example of FIG. 3, second optical feature 66 may be formed by directing suitable radiation through the first set of microlenses of plurality of lenses 64. The energy from the radiation source is directed toward the first set of microlenses and controlled to give a highly divergent beam of energy. For energy sources in the ultraviolet, visible, and infrared portions of the electromagnetic spectrum, the light is controlled by appropriate optical elements. In one embodiment, the optical elements may direct light toward the first set of microlenses with appropriate divergence or spread so as to irradiate the first set of microlenses and thus second layer 70.

In some examples, second optical feature 66 may be formed by directing collimated light from a laser through a lens toward the first set of microlenses with focal points within second layer 70. To create a floating image the light is transmitted through a diverging lens with a high numerical aperture (NA) to produce a cone of highly divergent light. As used herein, a high NA lens is a lens with a NA equal to or greater than 0.3. The second hinge side 58 is positioned away from the high NA lens, so that the axis of the cone of light (the optical axis) is substantially perpendicular to the plane of second layer 70 (e.g., the optical axis is substantially parallel to the z-axis of FIG. 3).

Because each microlens occupies a unique position relative to the optical axis, the light impinging on each microlens will have a unique angle of incidence relative to the light incident on each other microlens. Thus, the light will be transmitted by each microlens to a unique position within second layer 70, and produce a unique image, represented by the individual boxes of second optical feature 66.

A single light pulse produces only a single imaged dot within second layer 70, so to provide an image within second layer 70, multiple pulses of light are used to create that image out of multiple imaged dots. For each light pulse, the optical axis is located at a new position relative to the position of the optical axis during the previous pulse. These successive changes in the position of the optical axis relative to the microlenses results in a corresponding change in the angle of incidence upon each microlens, and accordingly in the position of the imaged dot created in second layer 70 by that pulse. As a result, the incident light focusing within second layer 70 by the microlenses images a selected pattern within second layer 70. Because the position of each microlens is unique relative to every optical axis, the image formed in the radiation sensitive material for each microlens will be different from the image associated with each other microlens.

Another method for forming floating composite images uses a lens array to produce the highly divergent light to image the radiation sensitive material within second layer 70. The lens array may include multiple small, high NA lenses arranged in a planar geometry. When the array is illuminated by a light source, the array produces multiple cones of highly divergent light, each individual cone being centered upon a corresponding lens in the array. The physical dimensions of the array are chosen to accommodate the largest lateral size of a composite image. By virtue of the size of the array, the individual cones of energy formed by the lenses will expose the radiation sensitive material in second layer 70 as if an individual lens was positioned sequentially at all points of the array while sequentially receiving pulses of light. The selection of which lenses receive the incident light occurs by the use of a reflective mask. This mask will have transparent areas corresponding to sections of the second optical feature 66 that are to be exposed and reflective areas where the image should not be exposed.

By having the mask fully illuminated by the incident energy, the portions of the mask that allow energy to pass through will form many individual cones of highly divergent light outlining the floating image as if the image was traced out by a single lens. As a result, only a single light pulse is needed to form the entire composite image in the radiation sensitive material within second layer 70. Alternatively, in place of a reflective mask, a beam positioning system, such as a galvometric x-y scanner, can be used to locally illuminate the lens array and trace the composite image on the array. Since the energy is spatially localized with this technique, only a few lenses in the array may be illuminated at any given time. Those lenslets that are illuminated will provide the cones of highly diverging light needed to expose the radiation sensitive material within second layer 70 to form the second optical feature 66.

The lens array itself can be fabricated from discrete lenslets or by an etching process to produce a monolithic array of lenses. Materials suitable for the lenses are those that are non-absorbing at the wavelength of the incident energy. The individual lenses in the array preferably have numerical apertures greater than 0.3 and diameters greater than 30 micrometers but less than 10 mm. These arrays may have antireflection coatings to reduce the effects of back reflections that may cause internal damage to the lens material. In addition, single lenses with an effective negative focal length and dimensions equivalent to the lens array may also be used to increase the divergence of the light leaving the array. Shapes of the individual lenslets in a monolithic array are chosen to have a high numerical aperture and provide a large fill factor of approximately greater than 60%.

By forming second optical feature 66 after assembling article 50 and by directing radiation through the first set of lenses of plurality of lenses 64, substantial registration or alignment between first optical feature 64 and second optical feature 66 is formed, because the images are formed within focal points of the microlenses in first optical feature 64. This may facilitate registration or alignment between first optical feature 64 and second optical feature 66, e.g., compared to forming first optical feature 64 and second optical feature 66 prior to attaching flexible hinge 52 to biodata page 54.

Although different optical features and different physical configurations of articles including a flexible hinge and a biodata page have been described herein with reference to separate examples, any features described with respect to an example may be used in any combination with any features described with respect to another example.

### EXAMPLES

### Example 1

A lensed hinge material was produced by micro-replicating an array of tightly packed lenses of an acrylate resin onto a roll of 100 micrometer (μm) thick polyurethane film (available under the trade designation PS 443-201, from Huntsman Chemical, The Woodlands, Tex.). The resulting lensed hinge material film was approximately 123 μm thick. The replicated lenses had a 47.0 μm radius of curvature and a negative 0.645 conic constant. The diameter of each lens was 86 μm with a center-to-center lens distance of 74 μm.

A laser engravable polycarbonate pre-laminated sandwich was fused by laminating a stack of 150 millimeters (mm) by 150 mm sheets of 3M™ Polycarbonate Security Film (available from 3M Co., St. Paul, Minn.) with a Carver® Press at 173° C. and 120 Newtons per square centimeter (N/cm²) for 18 minutes followed by 15 minutes of ramped cooling from 173° C. to room temperature as follows: 100 μm clear film/100 μm laser engravable film/250 μm white film/250 μm white film. Prior to lamination, a 25 mm×175 mm strip of Pacothane film (available from Pacothane, Winchester, Mass.) was placed along one edge of the sandwich between the 100 μm clear film and the 100 μm laser engravable film. After lamination, the Pacothane strip and the portion of the 100 μm clear film adjacent to the Pacothane strip were removed from the laminate, providing a 25 mm wide, 100 μm deep groove along one edge of the laminate.

A 40 mm×150 mm strip of the lensed hinge material was placed along the groove on the laminate such that a 15 mm tab was formed overhanging that edge of the laminate. This composite structure was laminated in the Carver® press at 173° C. and 40 N/cm² for 12 minutes followed by 15 minutes of ramped cooling from 163° C. to room temperature to bond the lensed hinge material to the groove and form an article comprising a flexible hinge and a biodata page.

The article was mounted to a flat stage and the microlens-containing area of the laminated construction was exposed to the output of an SPI fiber laser, expanded by a Lynos and Edmund Optics beam expander to a diameter of 25 mm. The expanded beam was input into a galvoscanner, which with the use of appropriate optics produced a focused beam having a numerical aperture of approximately 0.15. The focal point of the laser beam was located at approximately 8 mm above the surface of the laminate. Images were written via the laser beam into the laser engravable polycarbonate layer of the biodata page below where the lensed hinge material was fused to the biodata page. This formed a composite image of a signature that appeared to float above the microlens-containing portion of the flexible hinge material of the article.

Attempts to remove the hinge material from the biodatapage using scalpels, heat, and/or solvents caused a significant disruption in the floating signature. Attempts to re-form the disrupted floating signature by re-aligning and relaminating the flexible hinge to the biodata page were unsuccessful, i.e., the composite image was disrupted.

### Example 2

A lensed hinge material formed according to Example 1 was first imaged with a blue color floating image using the process of U.S. Pat. No. 7,981,499, the entire content of which is incorporated herein by reference. This lensed, imaged hinge material was attached to a biodata page as set forth in Example 1 and laser imaged with a signature using the same processes as set forth in Example 1. The article featured a blue color floating image and a black floating signature image, both images viewable through the same set of lenses at different viewing angles. Attempts to remove the hinge material from the biodata page using scalpels, heat and/or solvents caused significant disruption in the floating signature believed to be a result of the attempts to separate the two components, i.e., the hinge material from the remainder of the biodata page stack. In addition, as the polyurethane film was well bonded to the PC biodata page, attempts to remove the majority of the hinge material by splitting the PU layer disrupted the blue color floating image. Attempts to re-form either the floating image or the signature by re-aligning and re-laminating the biodata page material layers were unsuccessful.

### Example 3

A lensed hinge material was produced by micro-replicating of an array of tightly packed lenses of an acrylate resin onto a roll of 100 μm thick polyurethane film (available under the trade designation A95P5044, from Huntsman Chemical, The Woodlands, Tex.). The resulting lensed hinge material was approximately 125 μm thick. The replicated lenses had a 47.0 μm radius of curvature and a negative 0.645 conic constant. The diameter of each lens formed was 86 microns with a center-to-center lens distance of 74 microns.

The resulting lensed hinge material was pad-printed with UV-invisible ink (1565 GFA Invisible Yellow WB Flexo, available from Luminescence Inc., Harlow, Essex, United Kingdom) and dried in an oven for 10 minutes at approximately 50° C. The resulting lensed hinge material was cut to approximately 38 mm by 150 mm, and fashioned in a film sandwich with an adjacent layer of 100 μm thick 112 by 150 mm clear polycarbonate, on top of a stack of 1 layer of 100 μm thick laser engravable polycarbonate and 2 layers of 250 μm thick white polycarbonate at approximately 133 by 150 mm, such that a 17 mm tab portion of the lensed hinge material extended beyond the film sandwich. The film sandwich was fused by laminating with a Carver® Press at 173° C. and 120 N/cm² for 15 minutes followed by 15 minutes of ramped cooling from 173° C. to room temperature. The resulting laminated biodata page, a construction suitable for laser imaging as described in examples 1 and 2, maintained the patterned UV-invisible ink across the laminated and unlaminated portions of the hinge.

Various examples have been described. These and other examples are within the scope of the following claims.

1. An article comprising:
a flexible hinge comprising a first optical feature; and
a biodata page comprising a second optical feature, wherein the flexible hinge is attached to a biodata page surface, wherein the second optical feature is substantially aligned with the first optical feature

2. The article of claim 1, wherein the first optical feature and second optical feature produce an optical effect when in substantial alignment.

3. The article of claim 2, wherein the optical effect comprises at least one of a floating image or a Moire magnification effect.

4. The article of claim 2, wherein the optical feature represents personal information of a person associated with the biodata page.

5. The article of claim 1, wherein the first optical features comprises at least one of a plurality of lenses, an optical polarizer, a diffraction pattern, and an image.

6. The article of claim 5, wherein the first optical feature comprises the plurality of lenses, each of the lenses having a focal point, the focal points of a set of lenses of the plurality of lenses lying within the biodata page, and wherein the second optical feature comprises an array of images formed in the biodata page, each of the images lying within a focal point of one of the plurality of lenses.

7. The article of claim 6, wherein the biodata page comprises a layer of radiation sensitive material, and wherein the array of images is formed in the radiation sensitive material.

8. The article of claim 7, wherein the radiation sensitive material comprises a laser engravable polycarbonate.

9. The article of claim 7, wherein the set of lenses comprises a first set of lenses, wherein the plurality of lenses further comprises a second set of lenses, and wherein respective focal points of the second set of lenses are in registration with respective colored images formed on the second hinge surface.

10. The article of claim 5, wherein the first optical feature comprises the plurality of lenses, wherein the biodata page comprises a first layer comprising a first surface and a second layer comprising a second surface attached to the first surface, and wherein the second optical feature comprises an array of images formed on the first surface or the second surface.

11. The article of claim 5, wherein the first optical feature comprises the diffraction pattern, and wherein the biodata page comprises a first layer comprising a first surface and a second layer comprising a second surface attached to the first surface, and wherein the second optical feature comprises a pattern formed on the first surface or the second surface.

12. The article of claim 1, wherein the flexible hinge comprises a first hinge surface and a second hinge surface substantially opposite to the first hinge surface, wherein the first optical feature is formed in the first hinge surface, and wherein the first hinge surface is attached to the biodata page surface.

13. The article of claim 1, wherein the flexible hinge comprises a first hinge surface and a second hinge surface substantially opposite to the first hinge surface, wherein the first optical feature is formed in the first hinge surface, and wherein the second hinge surface is attached to the biodata page surface.

14. The article of claim 13, wherein the first hinge surface is attached to a portion of the biodata page surface.

15. The article of claim 13, wherein the first hinge surface is attached to substantially the entire biodata page surface.

16. The article of claim 13, wherein the first optical feature comprises a first portion of an image, wherein the second optical feature comprises a second portion of an image, and wherein the first portion of the image and the second portion of the image together form the image.

17. The article of claim 16, wherein at least one of the flexible hinge and the biodata page comprises a radiation-sensitive material, the radiation-sensitive material comprising at least one of the first portion of the image or the second portion of the image, and wherein the at least one of the first image and the second image is marked using radiation.

18. The article of claim 1, wherein the flexible hinge material comprises an elastomer.

19. The article of claim 1, wherein the flexible hinge is laminated to the biodata page surface.

20. The article of claim 1, further comprising at least one additional security feature incorporated in the flexible hinge, wherein the at least one additional security feature comprises at least one of a radio frequency identification (RFID) chip, one or more fluorescent dyes, one or more taggants, one or more surface structures, one or more embedded structures, one or more polarizing components, a color-shifting film, a security thread, guilloche printing, and color-shifting ink printing.

21. The article of claim 1, wherein the biodata page further comprises personal information associated with a holder of the biodata page.

22. The article of claim 1, further comprising a passport booklet, wherein the biodata page is attached to the passport booklet using the flexible hinge.

23. A method of forming an article comprising a biodata page, the method comprising:
forming a flexible hinge comprising a first optical feature; and
attaching the flexible hinge to the biodata page, wherein the biodata page comprises a second optical feature substantially aligned with the first optical feature when the flexible hinge is attached to the biodata page.

24. The method of claim 23, wherein the first optical features comprises at least one of a plurality of lenses, an optical polarizer, a diffraction pattern, and a printed pattern.

25. The article of claim 23, wherein the first optical feature comprises a plurality of lenses, each of the lenses having a focal point, the focal points of a set of lenses of the plurality of lenses lying within the biodata page, further comprising:
after attaching the flexible hinge to the data page, forming a plurality of images in the biodata page by focusing a radiation source through the set of lenses onto a radiation sensitive material within the biodata page, wherein each of the images lies within a focal point of one of the set of lenses.

26. The method of claim 25, wherein the radiation sensitive material comprises a laser engravable polycarbonate.

27. The method of claim 23, further comprising forming personal information associated with a holder of the biodata page on or within the biodata page.

28. An article comprising:
a flexible hinge including a plurality of lenses, each of the lenses defining a focal point; and
a layer comprising a radiation sensitive material, wherein the layer is attached to the flexible hinge, wherein focal points of a set of lenses of the plurality lenses lie within the radiation sensitive material.

29. The article of claim 28, wherein the radiation sensitive material comprises a laser engravable polycarbonate.

30. The article of claim 28, further comprising a plurality of images formed in the radiation sensitive material within one or more of the focal points.

31. A method comprising:
forming a flexible hinge comprising a plurality of lenses, each of the lenses defining a focal point; and
attaching the flexible hinge to a layer comprising a radiation sensitive material, wherein the focal points of a set of lenses of the plurality of lenses lie within the radiation sensitive material.

32. The method of claim 31, further comprising forming a plurality of images in the radiation sensitive material by focusing a radiation source through the set of lenses.
